(19) United States
(12) Patent Application Publication
(10) Pub. No.: US 2010/0081457 A1
(43) Pub. Date: Apr. 1, 2010

(54) TRANSACTION INFORMATION BASED MEET-UPS

(75) Inventors: Ceri Stuart Jerome, San Jose, CA (US); Manish Jain, San Jose, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc., san jose, CA (US)

(21) Appl. No.: 12/242,593

(22) Filed: Sep. 30, 2008

(51) Int. Cl. H04W 24/00

(52) U.S. Cl. 455/456.3

(57) ABSTRACT

A computerized method and system for organizing meet-ups based on transaction information are provided. Example embodiments may include receiving a selection of a geographic area from a first user and displaying a map of the geographic area including one or more item symbols. A location of an item symbol on the map may indicate a geographic location associated with a listing in a publication system. A designation of an event location to an event may be received from the first user. Information related to the event may be communicated to a number of invitees. The invitees may be related to one or more listings in the publication system associated with an inclusion zone defined by the first user.

### TECHNICAL FIELD

Example embodiments relate generally to the technical field of data management, and in one specific example, to a system and a method for organizing meet-ups based on transaction information.

### BACKGROUND

With the advancement of communication and networking technologies, more and more people spend time on the Internet, searching for information, shopping online, and participating in discussion forums and social networking. Service providers and online businesses try to reach potential clients and customers via online advertisements, electronic messaging, etc. Widespread use of handheld communication devices such as cell phones and personal data assistants (PDA) has also made users of such devices easy targets for online advertisements and online transactions.

### BRIEF DESCRIPTION OF THE DRAWINGS

Some embodiments are illustrated by way of example and not limitation in the figures of the accompanying drawings in which:

FIG. 1 is a high-level diagram depicting, in an example embodiment, a system for organizing meet-ups based on transaction information;

FIG. 2 is a block diagram illustrating an example embodiment of a system organizing meet-ups based on transaction information;

FIG. 3 is a block diagram depicting, in an example embodiment, components of a promotion module depicted in FIG. 2;

FIG. 4 is a high-level flow diagram showing an example method for organizing meet-ups based on transaction information;

FIG. 5 is high-level block diagram illustrating an example embodiment of a network-based publication system, having a client-server architecture, organizing meet-ups based on transaction information;

FIG. 6 is an example set of publication and meet-ups applications used by the network-based publication system of FIG. 5;

FIG. 7 is a diagram depicting a diagrammatic representation of a machine in the example form of a computer system;

FIG. 8 is a screen shot illustrating an example embodiment of a user interface used for organizing meet-ups based on transaction information;

FIG. 9 is a screen shot illustrating an example embodiment of a posting promoting a meet-up related to a listing in a discussion forum;

FIG. 10 is a screen shot illustrating an example embodiment of a posting promoting a meet-up related to a number of listings in an events section of a publication system; and

FIG. 11 is a screen shot illustrating an example embodiment of an email promoting a meet-up related to one or more listings via email.

### DETAILED DESCRIPTION

Example methods and systems for organizing meet-ups based on transaction information will be described. In the following description, for purposes of explanation, numerous specific details are set forth in order to provide a thorough understanding of example embodiments. However, it will be evident to one skilled in the art that the present subject matter may be practiced without these specific details.

Some example embodiments described herein may include organizing meet-ups based on transaction information. Example embodiments may include receiving a selection of a geographic area from a first user and displaying a map of the geographic area including one or more item symbols. A location of an item symbol on the map may indicate a geographic location associated with a listing in a publication system. A designation of an event location to an event may be received from the first user. Information related to the event may be communicated to a number of invitees. The invitees may be related to one or more listings in the publication system associated with an inclusion zone defined by the first user.

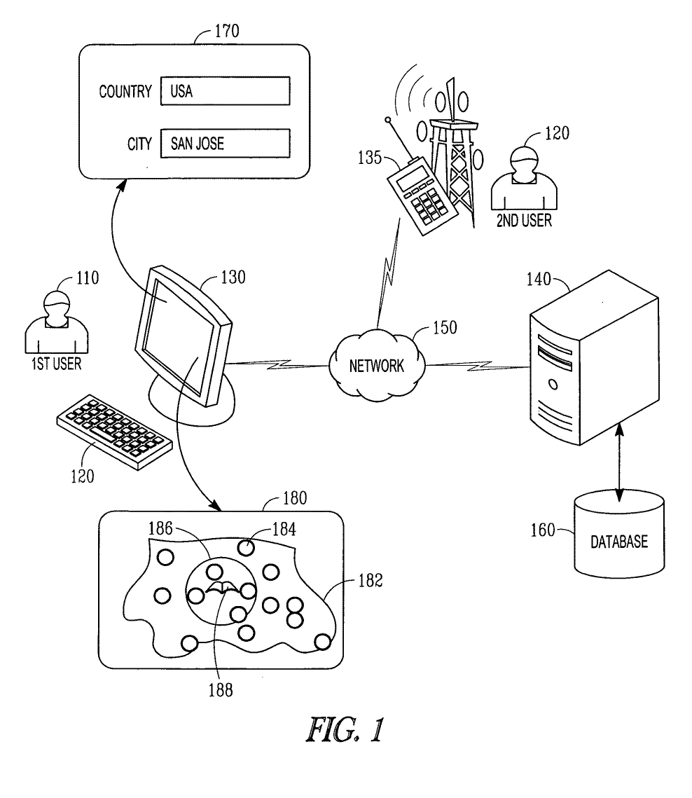

FIG. 1 is a high-level diagram depicting, in an example embodiment, functionality of a system for organizing meet-ups based on transaction information. A server 140 associated with an online publication system (e.g., eBay Inc. or Kijiji.com) may create a user interface 170 and receive, via the user interface 170 from a first user 110 of a client system 130 (e.g., a desk-top computer, a laptop computer, a personal data assistant (PDA), a cell phone, etc.) a selection of a geographic area (e.g., a name of a country and/or a city). The server 140 may display a user interface 180 including a map 182 of the geographic area including one or more item symbols 184. A location of an item symbol 184 on the map 182 may indicate a geographic location associated with a listing (e.g., a product or a service) in the online publication system.

The first user 110 may designate an event location (e.g., a meeting place, such as a coffee shop or public hall) for an event (e.g., a meet-up participated in by sellers/buyers of one or more listings). The server 140 may receive the event location from the first user 110. In an example embodiment, the server 140 may retrieve event locations from a database 160 including information associated with a number of meeting places that may be willing to participate in meet-ups. The server 140 may suggest these meeting places to the first user 110 to select from. The server 140 may communicate information related to the event (e.g., a location or a schedule of a meet-up) to a number of invitees. The invitees may be related to one or more listings in the online publication system associated with an inclusion zone 186. The inclusion zone 186 may be defined by the first user 110. For example, the first user 110 may request that buyers/sellers of listings with associated addresses within a predefined radius (e.g., 5 miles) from a location of a scheduled meet-up, represented by a symbol 188 on the map 182, be invited to the scheduled meet-up.

The server 140, in an example embodiment, may retrieve information related to the listings, including the associated addresses of listings, from the database 160 linked to the server 140. The server 140 may then communicate the information related to the listings to the client system 130 via a network 150 (e.g., the Internet). The server 140 may allow a second user 120 of a client system 135 (e.g., a desk-top computer, a laptop computer, a personal data assistant (PDA), a cell phone, etc.) linked to the network 150 to joint a meet-up organized by a first user 110.

The meet-ups may be organized based on transaction information. The transaction information may include information related to popular listings. The popularity of a listing may be determined based on a number of factors, including a number of bids, a number of closed transactions, association with a popular person, or feedback received from a number of buyers or seller of the listing. The server 140 may retrieve the transaction information stored in the database 160.

According to an example embodiment, the server 140 may display icons representing event locations and event schedules on the map 182. The server 140 may display additional information related to an event, in response to the second user 120 activating (e.g., by a mouse click, or a mouse over) an icon representing the location or the schedule of the event. For example, when the second user 120 activates an icon representing a location, the address of the event may be displayed in a new window. Also, when an icon representing a schedule is activated by the second user 120, the schedule including a date and a time of the event may be displayed to the second user 120.

The additional information displayed by the server 140 may include a list of listings participating in the event when the activated symbol represents the schedule of the event. The server 140 may promote the event via one of a messaging (e.g., electronic messaging, such as email or text message), posting in a forum, or posting in the online publication system.

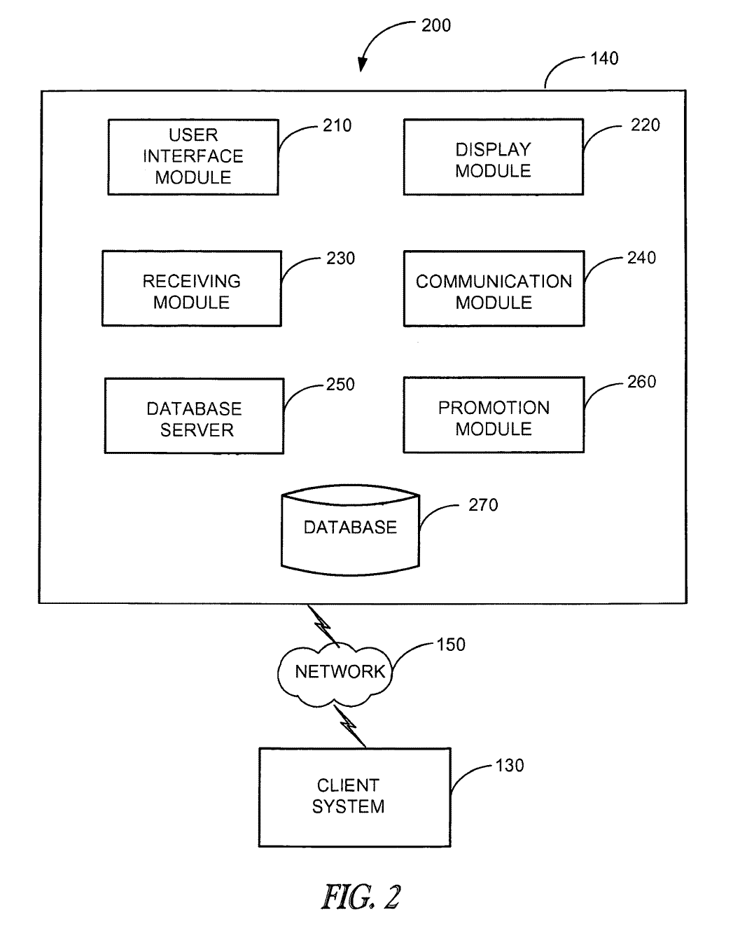

FIG. 2 is a block diagram illustrating an example embodiment of a system 200 for organizing meet-ups based on transaction information. The system 200 may include the server 140 and the client system 130. The server 140 may include a user interface module 210, a display module 220, a receiving module 230, a communication module 240, a database server 250, and a promotion module 260, and a database 270. These modules may be implemented by hardware, software or a combination of hardware and software. The server 140 may be linked to client system 130 via the network 150 (e.g., the Internet).

The user interface module 210 may receive a selection of a geographic area (e.g., a city, a country, a locality, a region, etc.) from a first user 110 (see FIG. 1). The user interface module 210 may create a user interface 170 (see FIG. 1) to receive the selection of the geographic area. For example, the user interface 170 may receive a name of a country and/or a city from the first user 110. Information associated with a map of a selected geographic location may be retrieved by the database server 250 from the database 270. The user interface module 210 may provide user interfaces that allow the second user 120 (see FIG. 1) to join the events.

The display module 220 may use the information associated with the map of the selected geographic location to prepare and display a map (e.g., the map 182 shown in FIG. 1) of the selected geographic location. The map of the selected geographic location may include a number of item symbols 184 (see FIG. 1). The item symbols 184 may represent listings of the online publication system within the selected geographic area. The location of an item symbol 184 on the map 182 may indicate a geographic location associated with a listing in the publication system. The geographic location associated with the listing may be an address stored for the listing in the database 270. The database server 250 may support retrieving the stored address for the listing from the database 270.

The display module 220 may display one or more event symbols at a location on the map associated with the event location. The event symbols includes an event location icon or a schedule icon. A receiving module 230 may receive a designation of an event location to an event from the first user 110 (see FIG. 1). The first user 110 may also designate an inclusion zone (e.g., inclusion zone 186 in FIG. 1) defined as an area surrounding the event location within a predefined radius (e.g., 5 miles). The receiving module 230 may also receive a location and a schedule of an event from the first user. The display module 220 may display the location or schedule of the event, in response to detecting by the user interface module 210, activation of the event location icon or the schedule icon by the second user.

The display module 220 may display additional information related to the event, in response to the second user 120 (see FIG. 1) activating the icon. In example embodiments, the display module 220 may display, in a separate window, a street address or a schedule of an event, whenever the icon representing the event is activated by the second user 120.

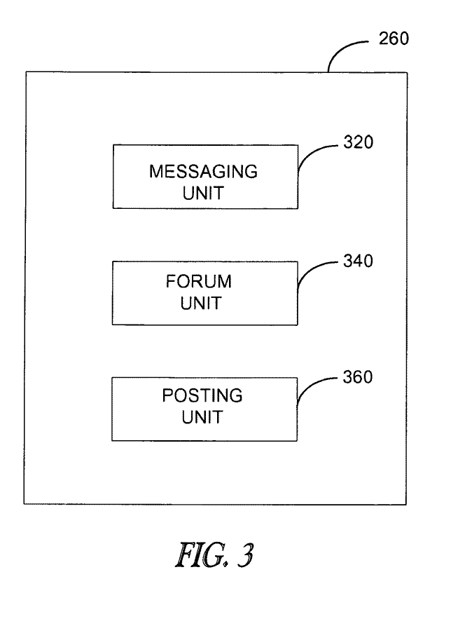

The communication module 240 may communicate information related to the event to a plurality of invitees. The invitees may be related to one or more listings in the online publication system with associated geographic locations within the inclusion zone. The events may be promoted by the promotion module 260. The promotion module 260, as shown in FIG. 3, may include a messaging unit 320, a forum unit 340 and a posting unit 360.

The messaging unit 320 may facilitate promoting the events by communicate messages, such as email and/or text messages to a client device (e.g., client system 130 in FIG. 1, such as a desk-top computer, a laptop computer, a personal data assistant (PDA), a cell phone, etc.). The messages may describe the events and may indicate the locations and schedules of the events. The forum unit 340 may use public forums to promote the events. The forum unit 340 may support forum members to exchange information related to the events (e.g., meet-ups). The information related to the events may include scheduled times and locations of events as well as information relating to participants and listings involved in the events. The posting unit 360 may facilitate posting of the events and information related to the events in one or more publication systems.

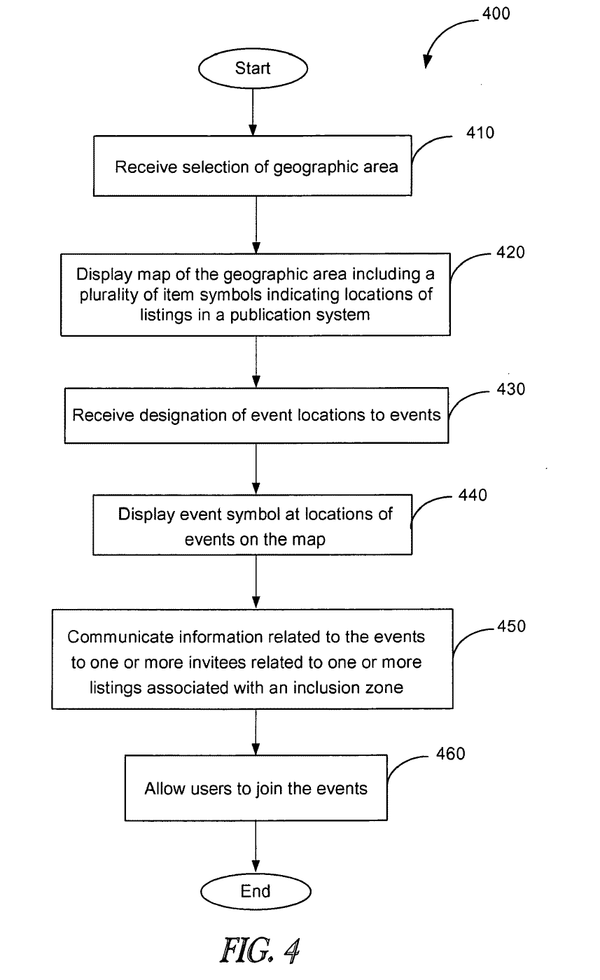

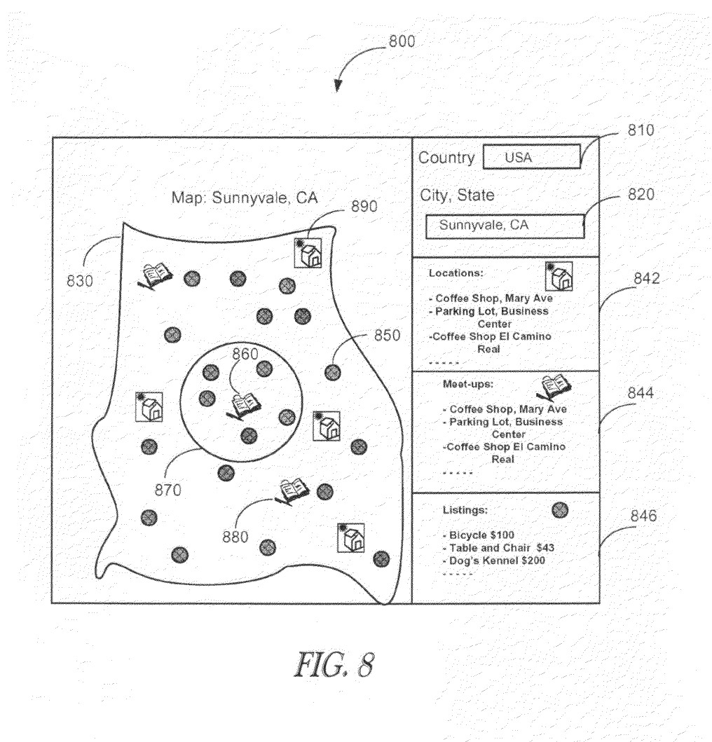

FIG. 4 is a high-level flow diagram illustrating an example method 400 for organizing meet-ups based on transaction information. At operation 410, the user interface module 210 (see FIG. 2) may receive a selection of a geographic area, for example, a country and/or a city (see callouts 810 and 820 in FIG. 8), from a first user 110 (see FIG. 1). The display module 220 (see FIG. 2) may display a map of the geographic area (see operation 420). The map may include a number of item symbols (e.g., item symbols 184 in FIG. 1 or listing symbols 850 and icons 880 and 890 in FIG. 8). The location of each item symbol on the map may indicate a geographic location associated with a listing in a publication system (see listing symbols 850 in FIG. 8).

At operation 430, the receiving module 230 (see FIG. 2) may receive a designation of an event location to an event from the first user 110 (see, for example, event locations 842 in FIG. 8). The event may include a meet-up related to one or more listings in the geographic area 830 (see FIG. 8). The display module 220, at operation 440, may display event symbols at locations on the map that corresponds to event locations. The event symbols may include icons representing a meet-up location or a scheduled meet-up location (see callouts 890 and 880 in FIG. 8).

The communication module 240 (see FIG. 2), at operation 450, may communicate information related to the events (e.g., location and schedule of meet-ups, listings invited to the meet-ups, etc.) to one or more invitees. The invitees may be related to one or more listings associated with an inclusion zone (see callout 870 in FIG. 8). In example embodiments, the invitees may be buyer/sellers of listings with addresses corresponding to locations within the inclusion zone. At operation 460, the server 140 (see FIG. 1) may allow users to join the events. For example, the users may respond to email messages or postings from the promotion module 260 (see FIG. 2) and enlist for participating in meet-ups promoted in the messages or postings.

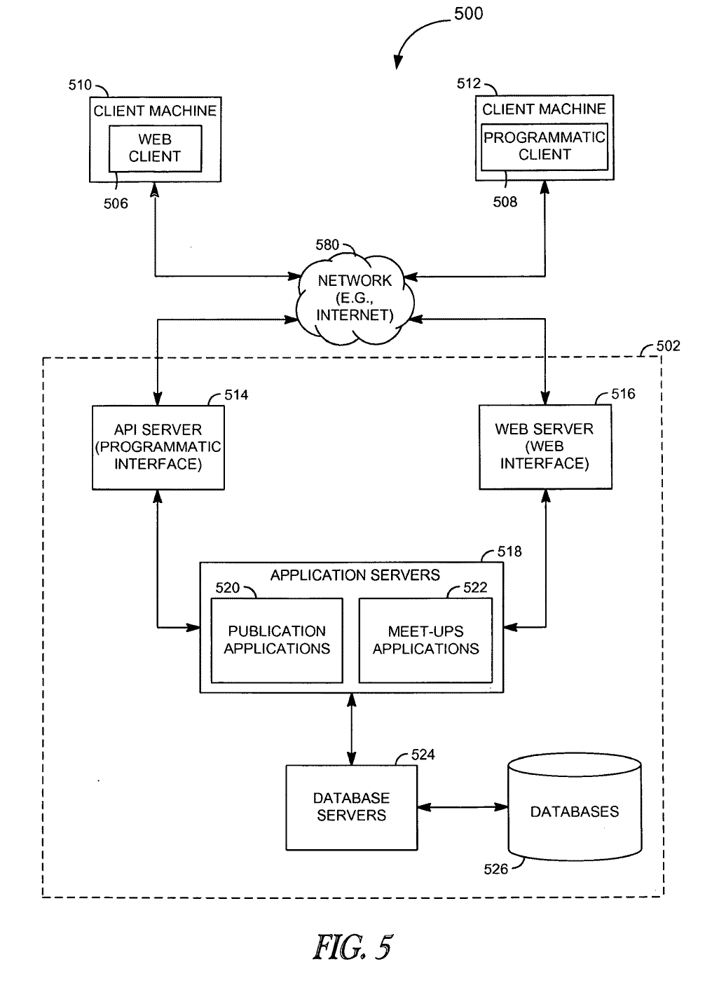

FIG. 5 is high-level block diagram illustrating an example embodiment of a network-based publication system 500 having a client-server architecture for organizing meet-ups based on transaction information. A publication platform, in the example form of publications server 502, may provide server-side functionality, via a network 580 (e.g., the Internet) to one or more clients. FIG. 5 illustrates, for example, a Web client 506 (e.g., a browser, such as the INTERNET EXPLORER browser developed by Microsoft Corporation of Redmond, Wash.), and a programmatic client 508 being executed on respective client machines 510 and 512.

Turning specifically to the publications server 502, an Application Program Interface (API) server 514 and a Web server 516 are coupled to, and provide programmatic and Web interfaces respectively to, one or more application servers 518. The application servers 518 host one or more publication applications 520 and meet-ups applications 522. The application servers 518 are, in turn, shown to be coupled to one or more database servers 524 that facilitate access to one or more databases 526.

The publication applications 520 may provide a number of publication functions and services to users who access the network-based publication system 500. For example, the publication applications 520 may support posting and browsing listings (e.g., items, services, etc.) in the network-based publication system 500. The meet-ups applications 522 may support organizing meet-ups based on transaction information and posting and browsing information related to meet-ups received from a first user and displaying a map of the geographic area including one or more item symbols in the network-based publication system 500.

Further, while the network-based publication system 500 shown in FIG. 5 employs a client-server architecture, the disclosed system is not limited to such an architecture and could equally well find application in a distributed, or peer-to-peer, architecture system.

The Web client 506 may access the publication and meet-ups applications 520 and 522 via the Web interfaces supported by the Web server 516. Similarly, the programmatic client 508 may access the various services and functions provided by the publication and meet-ups applications 520 and 522 via the programmatic interfaces provided by the API server 514. The programmatic client 508 may, for example, be a search application to enable buyers to search for listings of interest to the buyers in the network-based publication system 500. In another example embodiment, the programmatic client 508 may facilitate organizing meet-ups based on transaction information and support users by receiving a selection of a geographic area from the users, displaying a map of the geographic area including one or more item symbols, and receiving a designation of an event location for an event. The programmatic client 508 may also communicate information related to the event to a number of invitees using the network-based publication system 500.

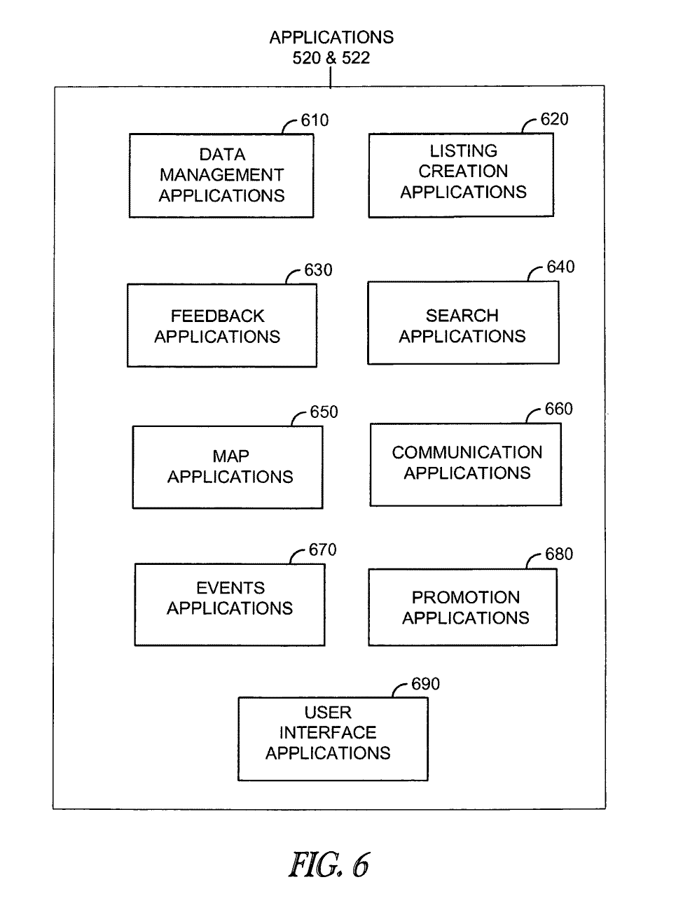

FIG. 6 is an example set of publication and social network applications used by the network-based publication system 500 of FIG. 5. The publications server 502 may provide the publication applications 520, whereby a user may post a listing or browse published listings in the network-based publication system 500. The publications server 502 may also provide the meet-ups applications 522 for organizing meet-ups based on transaction information and supporting posting and browsing information related to meet-ups received from a first user and displaying a map of the geographic area including one or more item symbols in the network-based publication system 500.

Various data management applications 610 may provide support for handling data, including storing and retrieving data related to various listings published in the network-based publication system 500. The data management applications 610 may facilitate the listing data to be categorized according to specific categories based on certain keywords.

A number of listing creation applications 620 may allow sellers or advertisers to conveniently author listings pertaining to goods or services that they wish to publish via the network-based publication system 500. The listing creation applications 620 may receive input data provided by the sellers or advertisers, and may have the data management applications 610 store the data in appropriate categories. The listing creation applications 620 may also provide listing information for the user interface applications 690 to display the listings to users.

Feedback applications 630 may support leaving feedback by users of the network-based publication system 500 related to their experiences with other users of the network-based publication system 500. For example, the buyer or seller of an item may rate the seller or buyer by leaving feedback (e.g., a positive, or a negative comment) for the seller or buyer of the item. The feedback applications 630 may be used by the network-based publication system 500 in deciding to organize meet-ups base on the transaction listings for which positive feedback is received. For example, if the feedback applications indicate that a seller is highly popular among buyers, event applications 670 may suggest that one or more new events (e.g., meet-ups) related to listings of the seller be organized.

A number of search applications 640 may support searching the databases 526 of the network-based publication system 500 for data items using search criteria received from a user of the network-based publication system 500. The map applications 650 may display a map of a local area defined by a first user. The map may include icons related to one or more listings in the network-based publication system 500. The map may also show event locations at which users may participate in events related to one or more listings.

The communication applications 660 may facilitate receiving search criteria from users of the network-based publication system 500. The communication applications 660 may also communicate user interface data, including meet-ups based on transaction information to the users. The communication applications 660 may also support communicating information including location and schedule of meet-ups.

One or more events applications 670 may support organizing events (e.g., meet-ups) related to transaction information. The events applications 670 may facilitate receiving information related to events, including a location and a time schedule. The events may be related to transactions, information of which may be retrieve from the databases 526 (see FIG. 5) of the network-based publication system 500.

A number of promotion applications 680 may provide support for promoting the meet-ups organized based on transaction information. The promotion applications 680 may prepare email messages to be communicated by the communication applications 660 to invitees of one or more meet-ups. The promotion applications 680 may also advertise the meet-ups by postings in one or more forums, or in a number of publication systems (e.g., the network-based publication system 500).

The user interface applications 690 may display various user interfaces (see, for example, FIG. 8) providing a map of a local area including icons representing one or more listings in the network-based publication system 500. The user interface applications 690 may also display user interfaces receiving information related to meet-ups, including location information and schedule of meet-ups form users. The user interface applications 690 may also display pages whereby users (e.g., buyers and sellers) may post advertisements for meet-ups in the network-based publication system 500.

### Machine Architecture

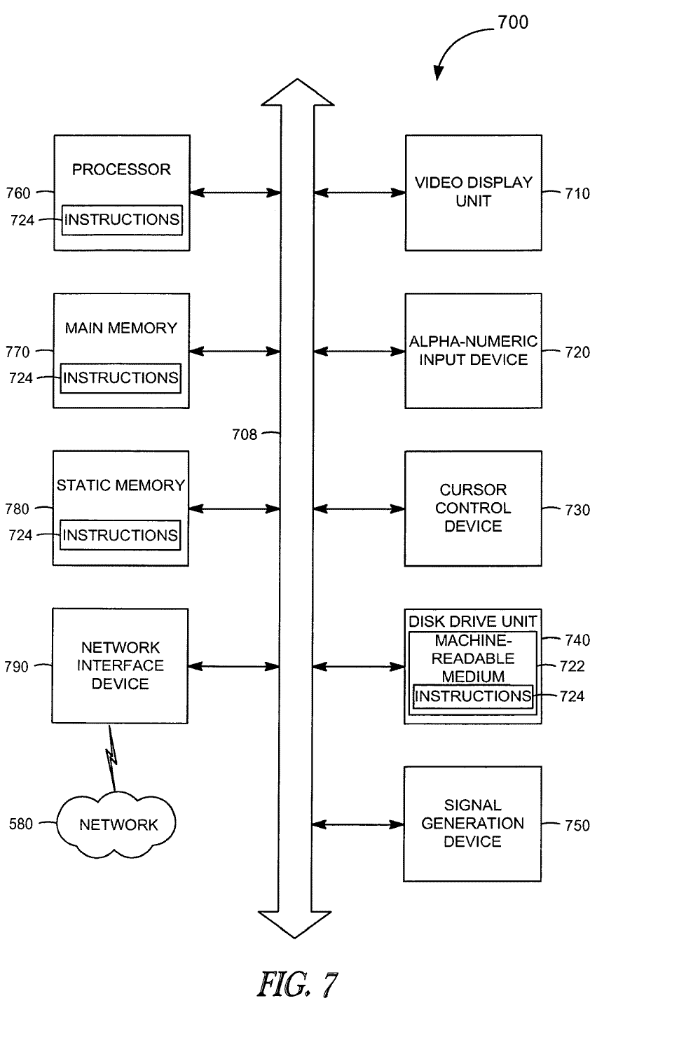

FIG. 7 is a diagram illustrating a diagrammatic representation of a machine 700 in the example form of a computer system, within which a set of instructions for causing the machine 700 to perform any one or more of the methodologies discussed herein may be executed. In alternative embodiments, the machine 700 may operate as a standalone device or may be connected (e.g., networked) to other machines. In a networked deployment, the machine 700 may operate in the capacity of a server or a client machine in a server-client network environment, or as a peer machine in a peer-to-peer (or distributed) network environment.

The machine 700 may be a server computer, a client computer, a personal computer (PC), a tablet PC, a set-top box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example machine 700 may include a processor 760 (e.g., a central processing unit (CPU), a graphics processing unit (GPU) or both), a main memory 770 and a static memory 780, all of which communicate with each other via a bus 708. The machine 700 may further include a video display unit 710 (e.g., a liquid crystal display (LCD) or cathode ray tube (CRT)). The machine 700 also may include an alphanumeric input device 720 (e.g., a keyboard), a cursor control device 730 (e.g., a mouse), a disk drive unit 740, a signal generation device 750 (e.g., a speaker) and a network interface device 790.

The disk drive unit 740 may include a machine-readable medium 722 on which is stored one or more sets of instructions (e.g., software) 724 embodying any one or more of the methodologies or functions described herein. The instructions 724 may also reside, completely or at least partially, within the main memory 770 and/or within the processor 760 during execution thereof by the machine 700, with the main memory 770 and the processor 760 also constituting machine-readable media. The instructions 724 may further be transmitted or received over a network 580 via the network interface device 790.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present technology. The term “machine-readable medium” shall accordingly be taken to include, but not be limited to, solid-state memories and optical and magnetic media.

### User Interfaces

FIG. 8 is a screen shot illustrating an example embodiment of a user interface 800 used for organizing meet-ups based on transaction information. The user interface 800 includes a dialogue portion, where a first user may indicate a geographic location by entering names of a country (e.g., USA) and a city, state (e.g., Sunnyvale, Calif.) in boxes 810 and 820, respectively. The user interface module 210 (see FIG. 2), in response to receiving the geographic location, may display a map 830 of the geographic location (e.g., Sunnyvale) including listing symbols 850 at locations associated with listings in Sunnyvale. The map may show icons 890 and 880 representing meet-up places and scheduled meet-ups, respectively, to indicate locations of tentative and scheduled meet-ups.

In example embodiments, the locations of the tentative meet-ups and scheduled meet-ups may also be indicated in portions 842 and 844 of the user interface 800. A list of items (e.g., listings) in the city of Sunnyvale may be included in a portion 846 of the user interface, where items may be listed along with item prices. The map 830 may display an inclusion zone 870 including a region surrounding a location 860 of a scheduled meet-up, having a radius defined by a first user. The communication module 240 (FIG. 2) may invite buyers/sellers of listings within the inclusion zone 870 to participate in the scheduled meet-up at the location 860.

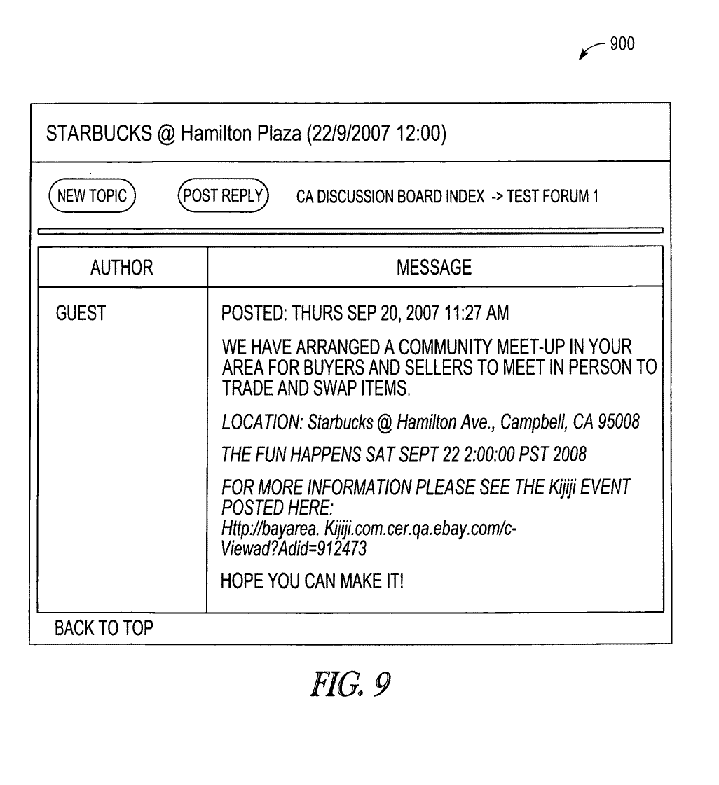

FIG. 9 is a screen shot illustrating an example embodiment of a posting 900 promoting a meet-up related to a listing in a discussion forum. The posting unit 360 (see FIG. 3) of the promotion module 260 (see FIG. 2) may facilitate promotion of meet-ups via postings in public forums. For example, the Author of the posting 900 may post information including a meet-up place (e.g., Starbucks@Hamilton Ave., Campbell, Calif. 95008) and a time and a date of a meet-up (e.g., 12:00 PST on Saturday September 2008) in a discussion forum (e.g., Ca discussion board). The posting 900 may also refer a user to a link (e.g., http://bayarea. Kijiji.com.cer.qa.ebay.com/c-Viewad?Adid=912473) for further information regarding the meet-up.

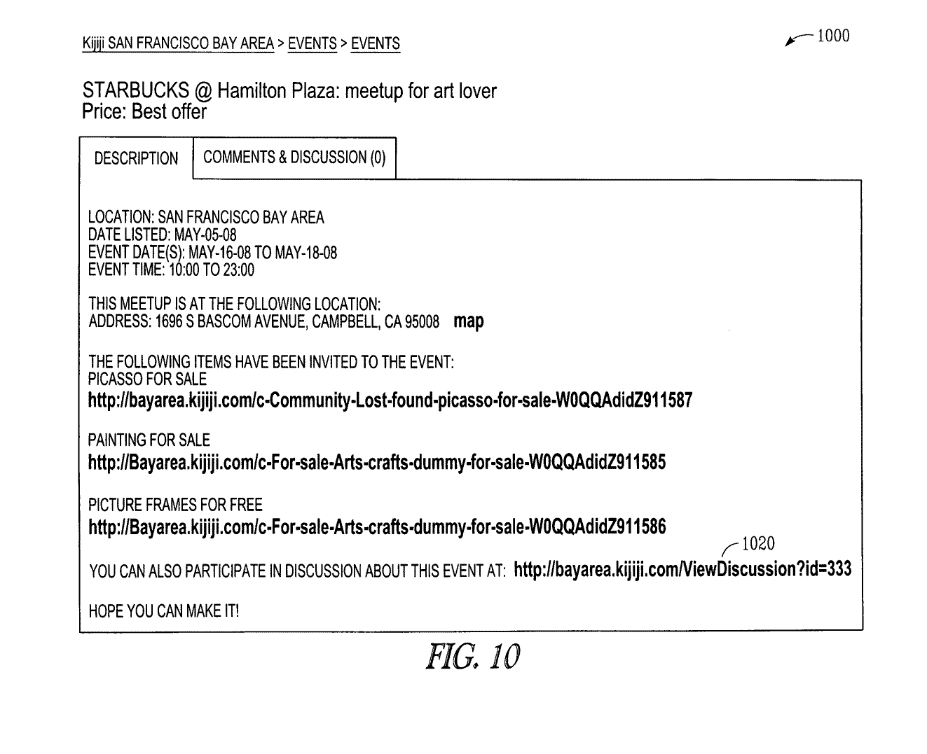

The posting unit 360 may also support promoting meet-ups related to a number of listings in an events section of a publication system as shown in FIG. 10. In an example embodiment, a screen shot of a posting 1000, illustrated in FIG. 10, may include a meet-up location (e.g., 1696 B. Bascom Avenue, Campbell, Calif. 95008), an event time (e.g., 10:00 to 23:00), and an event date (e.g., May 16, 2008 to May 18, 2008). The posting 1000 may also include a list of items that have been invited to the event, along with links to the items. A link 1020 to the meet-up webpage, where users may find more details regarding the meet-up, may also be provided by the posting 1000.

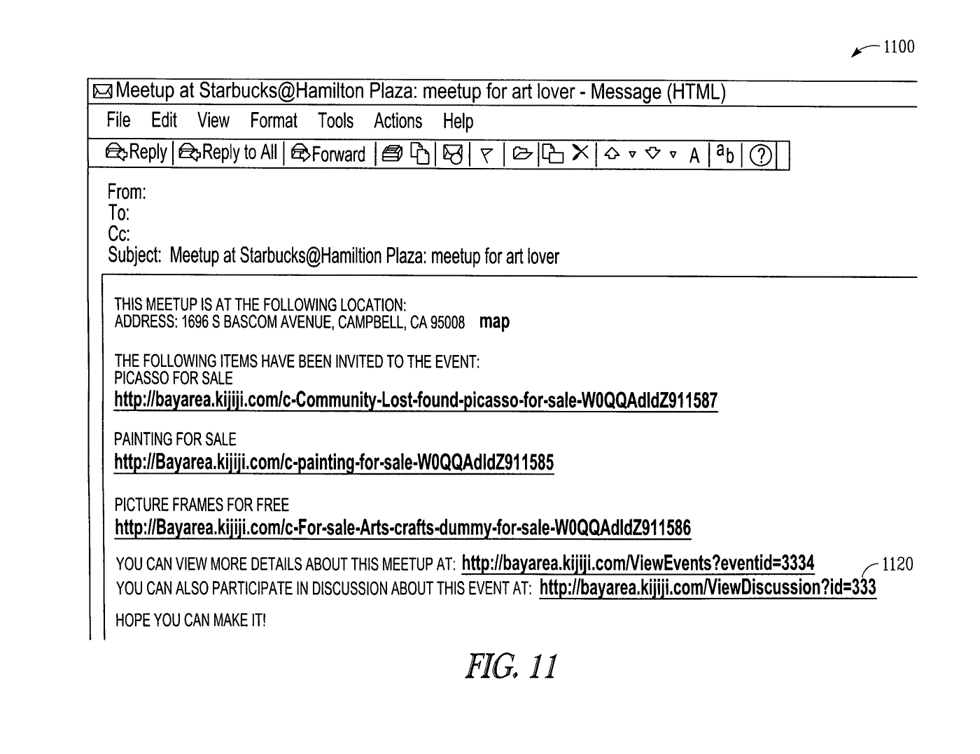

Referring to FIG. 11, a screen shot illustrating an example embodiment of an email message 1100 promoting a meet-up related to one or more listings is shown. The email message 1100 may be sent by the messaging unit 320 (see FIG. 3) to invitees with geographic locations within the inclusion zone 870 (see FIG. 8). The email message 1100 may indicate an address of a meet-up and provide a list of the items invited to the meet-up with links associated with the items. The email message 1100 may include a link 1120 to the meet-up webpage, where users may find more details regarding the meet-up.

Thus, a method and a system for organizing meet-ups based on transaction information have been described. Although the present subject matter has been described with reference to specific example embodiments, it will be evident that various modifications and changes may be made to these embodiments without departing from the broader spirit and scope of the subject matter. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computerized method comprising:
receiving a selection of a geographic area from a first user;
displaying a map of the geographic area selected by the first user, the map including a plurality of item symbols, a location of an item symbol on the map indicating a geographic location associated with a listing in a publication system;
receiving a designation of an event location to an event from the first user; and
communicating information related to the event to a plurality of invitees, the invitees being related to at least one listing in said publication system associated with an inclusion zone.

2. The method of claim 1, wherein the event includes a meet-up.

3. The method of claim 1, further including allowing a second user to join the event.

4. The method of claim 1, wherein the geographic area includes at least one of a country, a county, or a city.

5. The method of claim 1, further including displaying an event symbol at a location on the map associated with the event location.

6. The method of claim 5, wherein the event symbol includes an icon representing at least one of the event location, or a schedule of the event.

7. The method of claim 6, wherein the schedule of the event is received from the first user.

8. The method of claim 6, further including displaying additional information related to the event in response to the second user activating the icon.

9. The method of claim 8, wherein the additional information includes a meet-up schedule when an activated icon represents the event location.

10. The method of claim 8, wherein the additional information includes a date and a time associated with the event when the activated icon represents the schedule of the event.

11. The method of claim 8, wherein the additional information includes a list of listings participating in the event when the activated icon represents the schedule of the event.

12. The method of claim 1, wherein an invitee is at least one of a buyer or a seller of a listing for which there is an associated address within the inclusion zone.

13. The method of claim 1, wherein the inclusion zone defines an area surrounding the event location within a predefined radius designated by the first user.

14. The method of claim 1, further including promoting the event via at least one of messaging, posting in a forum, or posting in the publication system.

15. A system comprising:
a user interface module to receive a selection of a geographic area from a first user;
a display module to display a map of the geographic area selected by the first user, the map including a plurality of item symbols, a location of an item symbol on the map indicating a geographic location associated with a listing in a publication system;
a receiving module to receive a designation of an event location to an event from the first user; and
a communication module to communicate information related to the event to a plurality of invitees, the invitees being related to at least one listing in said publication system associated with an inclusion zone.

16. The system of claim 15, further including a database server to retrieve from a database geographic location information associated with a plurality of listings in the publication system.

17. The system of claim 15, wherein the display module is to display an event symbol at a location on the map associated with the event location.

18. The system of claim 15, wherein the receiving module is to receive a schedule of the event from the first user.

19. The system of claim 17, wherein the display module is to display additional information related to the event in response to the second user activating the event symbol.

20. The system of claim 15, further including a promotion module to promote the event via at least one of messaging, posting in a forum, or posting in the publication system.

21. A system comprising:
means for receiving a selection of a geographic area from a first user;
means for displaying a map of the geographic area selected by the first user, the map including a plurality of item symbols, a location of an item symbol on the map indicating a geographic location associated with a listing in a publication system;
means for receiving a designation of an event location to an event from the first user;
means for displaying an event symbol at a location on the map associated with the event location; and
means for communicating information related to the event to a plurality of invitees, the invitees being related to at least one listing in said publication system associated with an inclusion zone.

22. The system of claim 21, further including means for displaying an event symbol at a location on the map associated with the event location, wherein the event symbol includes an icon representing at least one of the event location or a schedule of the event.

23. The system of claim 22, further including means for displaying additional information related to the event in response to a second user activating the icon, wherein the additional information includes a date and a time associated with the event when the activated icon represents the schedule of the event.

24. A machine-readable medium comprising instructions, which when executed on a machine, perform the following operations:
receiving a selection of a geographic area from a first user;
displaying a map of the geographic area selected by the first user, the map including a plurality of item symbols, a location of an item symbol on the map indicating a geographic location associated with a listing in a publication system;
receiving a designation of an event location to an event from the first user;
displaying an event symbol at a location on the map associated with the event location, the event symbol including an icon representing at least one of the event location, or a schedule of the event.
communicating information related to the event to a plurality of invitees, the invitees being related to at least one listing in said publication system associated with an inclusion zone.

25. The system of claim 24, further including displaying additional information related to the event in response to a second user activating the icon, wherein the additional information includes a date and a time associated with the event when the activated icon represents the schedule of the event.
